(19) United States
(12) Patent Application Publication
(10) Pub. No.: US 2022/0183927 A1
(43) Pub. Date: Jun. 16, 2022

(54) METHODS CIRCUITS DEVICES ASSEMBLIES AND SYSYEMS FOR TREATING A THERAPUTIC SOLUTION

(71) Applicant: Hannan Noyman, Tel Aviv (IL)

(72) Inventor: Hannan Noyman, Tel Aviv (IL)

(21) Appl. No.: 17/644,058

(22) Filed: Dec. 13, 2021

Related U.S. Application Data
(60) Provisional application No. 63/124,279, filed on Dec. 11, 2020.

(51) Int. Cl. A61H 35/00; C02F 1/00; C02F 1/32

(52) U.S. Cl. CPC A61H 35/00; C02F 1/001; C02F 2103/42; A61H 2035/004; A61H 2201/01; C02F 1/32

(57) ABSTRACT

Disclosed are methods, circuits, devices, assemblies and system for treatment of a highly concentrated therapeutic solution of salts and minerals in water. According to some embodiments, a system for solution treatment, integral or otherwise functionally associated with a pool, may include a combination of filters, heaters, antimicrobial reactors and injectors.

### RELATED APPLICATIONS

The present application claims priority from U.S. Provisional Patent Application No. 63/124,279, filed on 11 Dec. 2020, and the entire disclosure of which is hereby incorporated by reference.

### FIELD OF THE INVENTION

The present invention relates generally to the field of water treatment. More specifically, the present invention relates to methods, devices, assemblies and system for treating a concentrated solutions of salt and mineral in water, which solution may be used to provide a therapeutic bath within a pool of the concentrated solution.

### BACKGROUND

Mankind has often been in wonder at the amazing phenomenon Nature has provided possible, and in many cases has failed in replicating said phenomenon. One such phenomenon is the amazingly therapeutic water solution of the Dead Sea. The Dead Sea was known in biblical time as Sea of Salt “Yam Hamelach” (Genesis 14:30) the lowest point in the world, with an altitude of −420 Meters below sea level, has been in existence for millions of years and produced one of the most spectacular natural phenomenon known to mankind—it's supersaturated waters which in addition to fully floating grown men and women, exhibit various therapeutic properties on human skin, joints, bones and general sense of wellbeing.

Throughout history the Dead Sea has been recognized for its incredible therapeutic properties which derive from the unique properties of the water of the Dead Sea containing more than 6 different salts and 26 minerals with the highest salt (35%) concentration in the world. Every year large numbers of people from all over the world come to the lowest point of the world to experience the therapeutic effect that the Dead Sea has to offer. The main attraction of it is the floating experience which provides healing properties and zero gravity experience due to the concentrated Salt & Mineral water, there are many benefits to the body including pain management, solutions for various skin conditions, relaxing effects on the nervous system and other benefits that contribute to wellbeing.

Given the properties of this water solution, many attempts have been made over the centuries to replicate the composition and unique properties of the Dead Sea water. Many have attempted to provide pools with similar characteristics to the Sea Sea that would replicated the Dead Sea experience in a controlled environment. Till today, all attempts at creating a highly accurate replica of the dead sea and its water have failed. More specifically:

Attempts in the past to transfer saltwater from the Dead Sea to small pools in therapeutic health care facilities and recreational sites failed because in two weeks of use, the waters started losing its original properties for therapy purposes. Additionally, due to the highly dense and corrosive properties of the water, there is an issue with a short life span of the equipment used. Most regular sea water equipment is damaged very quickly handling dead sea saltwater or the like. This results in very high equipment maintenance costs and the need to dump water to the sewage when failure occurs—further resulting in waste, unfriendly environmental conditions and high costs of operation.

In order to facilitate the therapeutic benefits of Dead Sea water to people around the world, there is a need for a set of innovations in the field of water storage and treatment to provide high-efficiency storage, use and processing of dead sea, or dead sea like, solutions.

### SUMMARY OF THE INVENTION

The present invention includes methods, devices, systems and assemblies for the treatment of a highly concentrated salt and mineral solutions in water used for human therapeutic bathing. According to some embodiments, the therapeutic solution may be a fluid from the Dead Sea and may be transported to a pool where users or subjects of the therapy use of the solution. Use of the therapeutic solution may include immersing at least a portion of the subject's torso in the therapeutic solution and or in some cases floating in the therapeutic solution for some period of time. According to alternative embodiments, the therapeutic solution may be sourced various natural or manmade sources of water highly saturated with salts and or minerals.

According to some embodiments, treatment of the therapeutic solution may include three stages: (1) removing biomatter or other type of impurities deposited by a use of the therapeutic solution, (2) replenishing water which either evaporates or is carried away one the bodies or clothes of users of the therapeutic pool, and (3) replenishing salts and minerals carried away on the bodies and clothes of users of the therapeutic pool. Cleaning of the solution may be performed by a multistage filtration system through which the solution is circulated. Water loss compensation may be achieved using a distilled water injector which may introduce additional water into the solution responsive to output of one or more sensors monitoring a composition of the therapeutic solutions. Salt and mineral loss compensation may be achieved using a solute injector which may introduce additional salts and or minerals into the therapeutic solution. The addition of specific salts and or specific minerals may be responsive to output of one or more sensors monitoring the composition of the therapeutic solutions, such that a detected drop in concentration of a given salt or mineral in the solution may trigger the injector to add that given salt and or mineral.

According to some embodiments, at least one of the one or more sensors monitoring the composition may be used to detect one or more solute concentrations in the solution. According to further embodiments of the present invention, the solute concentration sensors may operate at least partially using spectrographic principles. The output of the solute concentration detection sensors may be received by a system controller, including processing logic and application specific code for the present application. The controller may, responsive to the received sensor output, cause a functionally associated solute injector to inject into the solution various amounts of salts or minerals whose respective concentrations have dropped. The injected quantities may be calculated by the controller to be an amount estimated to bring each of the degenerated salt and or mineral concentration levels back to original or otherwise preferred concentration ranges.

According to embodiments of the present invention, the majority of therapeutic solution in use may be help in an open pool in which users may enter from the top. The pool may be composed of a durable polymer resistance to breakdown due to salts or minerals. Around the periphery of the pool may be located drainage or spill-off channels to receive and contain therapeutic solution spilling over the top of the pool. The channels may carry the spill-off into intermediate storage reservoirs which hold spill-off before it enters the treatment pipeline comprising multiple filters, at least one heater, at least one antimicrobial processing chamber, and optionally one or more injectors. A pump may urge the solution from the intermediate storage reservoirs through the treatment pipeline and back into the pool through a return path or line. The return path may include pipes connecting an end-point of the treatment pipeline or path to inlets in and or around the pool surface.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows an illustration with a prospective view of a therapeutic pool along with a therapeutic solution treatment system according to embodiments of the present invention;

FIG. 2 shows a mechanical drawing with cross sections of an exemplary pool with a spill-off channel and intermediate/holding/pre-treatment reservoirs according to embodiments of the present invention; and

FIG. 3 shows piping and machine arrangement drawing illustrating an exemplary solution treatment system according to embodiments of the present invention; and

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “treatment”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

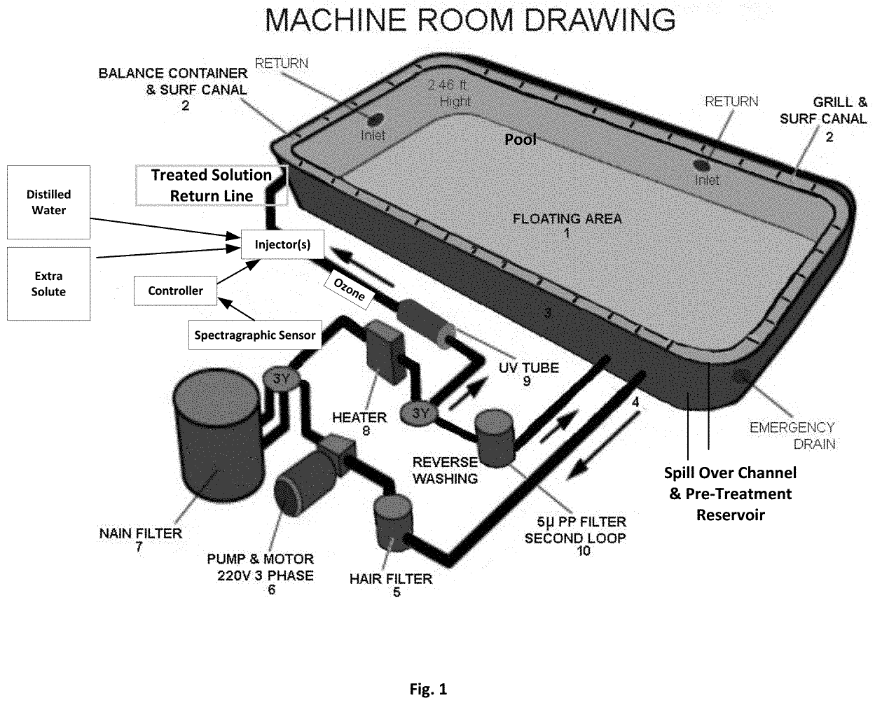

Turning now to FIG. 1, there is shown an illustration of a Dead Sea pool with solution treatment system in accordance with embodiment exemplary embodiments of the present invention. The embodiment of FIG. 1 includes a Dead Sea therapeutic pool with an open top for providing user access and floating, and a therapeutic solution treatment system for the highly concentrated liquid solution of salts and minerals in water held in a pool. The combined pool and solution treatment system may include a main pool reservoir where people swim and a second reservoir for contaminated solution. The uncleaned water that is dropped from the floating area of a pool is stored in the intermediate pre-treatment reservoirs which includes also include channel leading unclean water solution towards a treatment process including filtration, heating and possibly material injection. The reservoir may receive solution from the pool through a pool solution spill-off collection channel. The reservoir may be called a holding, intermediate and or pre-treatment reservoir.

The filtration process or chain or pipeline of the system may include a coarse biomaterial filter for receiving from the holding reservoir pool spill-off solution and removing therefrom user deposited bio-materials. A second filter may be a particle filter configured for particles of 1-30 microns and suitable for removing particles from the pool spill-off solution. The treatment chain may include a heater for continuously raising or maintaining a temperature (the heater may be heating the water continuously to a specific temperature) of the filtered solution. The heater increases a saturation point of the spill-off solution.

Embodiments of the present invention may include a photonic emitter for irradiating bacteria, viruses and fungus cells in the solution heated solution. The system also include an ozone water cleaner or reaction chamber that kills bacteria, viruses and fungus cells in the solution heated solution.

The system may further include a pump for providing pressure to urge the spill-off solution from the intermediate reservoir and then through one or more filters and the photonic and ozone chambers. The pump pulls the spill-off solution through said biomaterial filter. The pump pushes the spill-off solution through the particle filter.

The system includes a spectrograph and configured to at least intermittently measure quantities or concentrations of specific salts or minerals dissolved or suspended with the spill-off solution. Said spectrograph is in-line with a return path of the spill-off solution and configured to at least intermittently measure quantities or concentrations of specific salts or minerals dissolved or suspended with the spill-off solution flowing in the return path.

The system further including a supplemental materials injectors to introduce into the solution materials detected by said spectrograph to be below a predefined concentration within the solution. The injector is location near the heater to provide solute when the saturation point is increased.

There system includes a cleaning mechanism which uses backward flow solution liquid to remove filtered into a waste reservoir. Regular removal of particles from the particle filter works in order to extend usability while preserving said solution.

Further details on system of FIG. 1 include:

Stand alone floating pool system that treats and purifies Dead Sea water in its natural water state. The floating pools are manufactured by PP (polypropylene)material which is designed to be built in many shapes and sizes based on the customer specifications needs. The system is a complete dosed loop system without the need of adding any chemicals to treat the water. The water 35% of salt content has self-cleaning antiseptic properties that go through a complete process of purification every 22 minutes using a unique filtration system and UV lighting. The system is environmentally friendly without the hook to the sewage or any need of drainage.

The Floating pools may be produced from PP (polypropylene) the PP material sustains the natural state of the Dead Sea water withstanding the high salt content of 35% up to 100%. The floating pool is built for mobility and has a plug and play installation concept for easy hookups and disassemble which makes it easy to plug and unplug the system if needed.

The depth of the pool is manufactured to be shallow 2.46 ft in depth for supine position (lying horizontally) to fit the floating experience (Zero Gravity) which added: (a) Enhanced safety with pool operations dealing with the harsh water of high salt content, (b) it is build for friendly operation for handicap usage, (c) by decreasing the total volume of water content we have substantially reduced the cost of the pool operation with Dead Sea water cost, and raw materials needs, (d) easy cleaning operations, (e) contributed to reduced calcification of salts on the pool surface. The uniqueness of the pool design is that all of the compartments of the floating pool are designed and manufactured as one block unit which includes the center layer, surface canal, and the balance container layer there is no need to install or to constructed it separately. The whole system integration is unique by using several working mechanism that works in synchronization to meet the highest international standards for public use,

### 1. The Pool and Ancillary Structures

The structure is manufactured from PP (polypropylene) which after prolonged testing we concluded that the PP material can sustain the harsh water environment of very high salt levels which are between 1%-100% of salts as well as sulfur. Our method of manufacturing allows us to custom build the floating pools into many different shape configurations and sizes because of the material characteristics and its flexibility in the manufacturing process.

The main compartment—The main compartment consists of a center structure that has two layers the center layer where the water are present for the floating experience, the second layer is the surface canal which the water flow in free fall with the dirt and contaminants directly to the balance container layer which is a step reservoir that the water is passing through where it is pumped back to the machine room for cleaning and recycling.

### 2. The Machine Room:

The Machine room has unique characteristics to treat the unique Dead Sea Water composition. The goal of the system is to treat the water by keeping its natural state and the same time purifying the water by removing all contaminants and sediments without the usage of any chemicals.

There are several components in the machine room worth noting:

Station one is a sand filter that attracts and filters the sediments and contaminates of a bigger size units, (b) Station two the water goes through the heating system in which the water is being heated to a temperature between 30-41 degrees Celsius and from there the water goes to (c) Station three which is the purification process were the water goes through a custom-made UV system which kills fungus and bacteria's in the rate of 5 times greater than chlorine and other chemicals. (d) Station Four the water is pumped back into the pool using our unique build pumps that is durable with such a high salt environment.

The pool may include a lighting system which is part of the whole unit which is constructed into the pool surface. The lights are LED specialized to work with the Dead Sea harsh water environment and meets international standards.

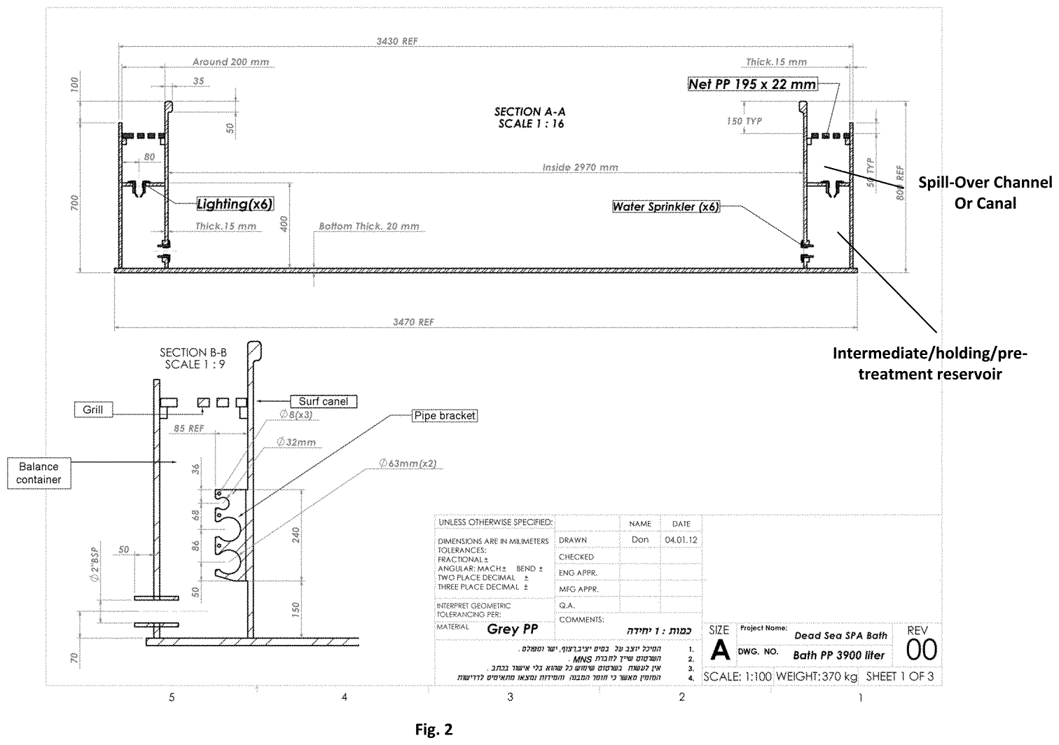

Turning now to FIG. 2, there is shown a mechanical drawing illustrating cross sectional view of the pool and waste reservoirs.

3. Floating Pool Structure with Flow Description (FIG. 1.1)

The Floating pool center layer (Inner circle were people float)—is the surface where the floating takes place.

The Surf Canal—A 360 degrees canal that is designed for a water free fall into the Balance container. The surf canal is at the same level as the inner circle (where people float) it allows for water free fall that carries dirt and contaminants to go into the Balance container layer without resistance or obstructions on the way.

The Balance container layer—An innovative design that is unique to the pool industry where the balance container is designed as a 360 degrees surrounding circular container just below the surf canal where all the water with dirt and contaminants free fall into to be pumped through the outlet pipe to the machine room cycle for proper treatment.

Machines Room Components with Flow Description

Water outlet—The pipe is connected to the balance container where the water from the balance container is pumped into the machine room for

further treatment.

Hair filter—water from the balance goes through a hair filter.

Pump—Fitted to work with high salt contents pumps the water into the main filter.

The main filter—Is a standard sand filter where the water from the pump is flowing into.

Heater—The water from the main filter (sand filter) flows to the heater where the water is heated to a max of 41 degrees celsius, once it passes the heather it goes to the UV tube.

The UV tube is a custom made system that is built to work with the high content salt water which kills fungus and bacterias in 5 times more than any other chemical known in the market.

The water from the UV system goes back in a closed loop into the pool area 1 (floating area)

Reverse wash filtration operation—The reverse cleaning operation invented to remove all the accumulated contaminants and dirt from the main filter to be captured in the reverse filter (#11) The Reverse cleaning process is designed to take place at the end of the day shift. The innovation with that process was designed to clean the main filter using only the balance container water in order to save in wasting any outsource water and use the actual water in the system. The Reverse cleaning takes between 10 minutes. Once the process is done. The operator will turn on

the normal flow operation. Once the normal water flow is turned back on the operator will open the Reverse filter (#11) and remove the dirt bucket.

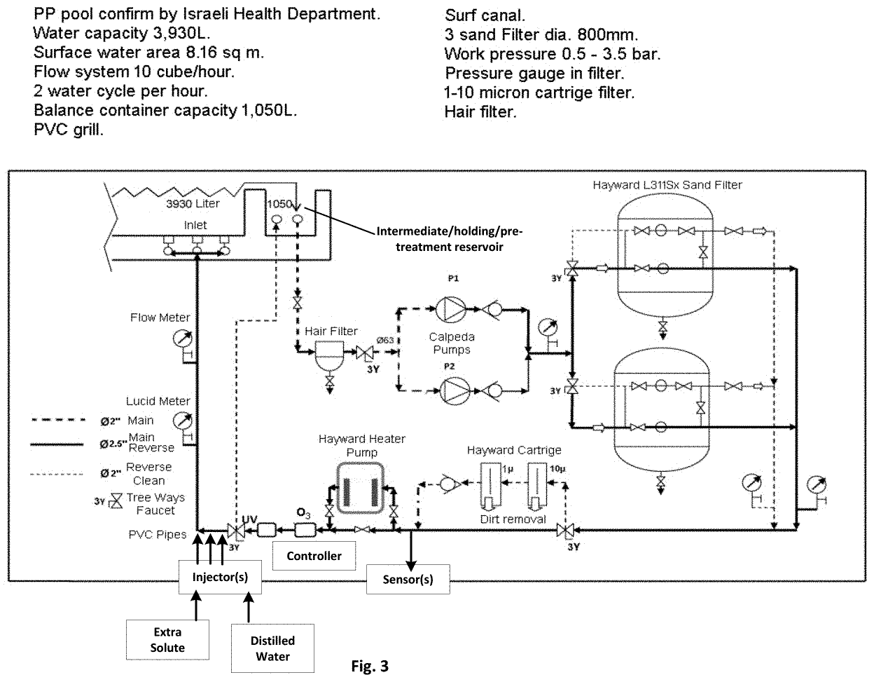

Turning now to FIG. 3, there is shown a piping and machine level drawing of an exemplary treatment system according to some embodiments of the present invention. Operation of constituent components of the system may be described in the context of the following description of three operational phases:

I. Normal Working Operation
1. The pump urges solution to and through the main filters.
2. The solutions flows from the main the filter to the O3 and UV chambers or reactors.
3. Then the solution flows through the heater pump.
4. From there the water flow back to the pool going through a 2″ PVC pipe straight to the inlet (center pool layer which is the POOL floating area.
5. The pool top off and when over flow happens it spills-off by gravity free falling between 1.5-2 ft to the 360 degree reservoir around the center layer.
6. The pump pulls the water from the 360 degrees reservoir using a 2.5″ diameter PVC pipe into the hair filter and then through pump to create another circle close loop.

II. The Reverse Washing and Cleaning:
1. The controller/computer stops the pumps to stop the regular directional flow.
2. The 3 way valves are switched to the reverse option flow.
3. The computer turns on the pump to the reverse settings.
4. The pump starts the cycle of pulling the water from reservoir around the pool into the hair filter, then through the pump, and then it passes through the main filters in a reverse motion to pull all the dirt to the specialized 1-10-micron PP filter collector tank to be collected.
5. After the water is being cleaning by the 1-10 Micron collector it then goes directly into the O3, UV, and flow back into reservoir through a 2″ PVC pipe diameter.
6. The reverse cycle is conducted over 10 Minutes. This cycle happens daily after work hours or when needed.

III. Switching Back into Normal Working Operation:
1. The computer switches the pumps off.
2. The valves turn back to normal operations position Which then the cycles go back to normal flow settings.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A liquid solution treatment system for a highly concentrated liquid solution of salts and minerals in water held in a pool with an open top for providing user access, said liquid solution treatment system comprising:
a pool solution spill-off collection channel and holding reservoir;
a coarse biomaterial filter for receiving from said holding reservoir pool spill-off solution and removing user deposited bio-materials from the received spill-off solution;
a particle filter for removing particles from the pool spill-off solution;
a heater for raising the temperature of the double filtered solution; and
a photonic emitter for irradiating bacteria, viruses and fungus cells in the solution heated solution.

2. The liquid solution treatment system of claim 1, further comprising a pump for providing pressure to urge the spill-off solution through one or more filters.

3. The liquid solution treatment system of claim 2, wherein said pump pulls the spill-off solution through said biomaterial filter.

4. The liquid solution treatment system of claim 3, wherein said pump pushes the spill-off solution through the particle filter.

5. The liquid solution treatment system of claim 1, wherein said heater raises a temperature of the spill-off solution and increases a saturation point of the spill-off solution.

6. The liquid solution treatment system of claim 1, including a spectrograph and configured to at least intermittently measure quantities or concentrations of specific salts or minerals dissolved or suspended with the spill-off solution.

7. The liquid solution treatment system of claim 6, wherein said spectrograph is in-line with a return path of the spill-off solution and configured to at least intermittently measure quantities or concentrations of specific salts or minerals dissolved or suspended with the spill-off solution flowing in the return path.

8. The liquid solution treatment system of claim 6, further including a supplemental materials injectors to introduce into the solution materials detected by said spectrograph to be below a predefined concentration within the solution.

9. The liquid solution treatment system of claim 8, wherein the said injector is location adjacent to said heater.

10. The liquid solution treatment system of claim 9, wherein said particle filter includes a cleaning mechanism which uses non-solution liquid to remove filtered into a waste reservoir particles from the particle filter in order to extend usability while not preserving said solution.

11. A pool system comprising:
a pool with an extra-durable lining, a cavity for holding a therapeutic liquid solution of salts and minerals in water and an open top to provide user access;
a pool solution spill-off collection channel and holding reservoir; and
a liquid solution treatment system comprising:
a. a coarse biomaterial filter for receiving from said holding reservoir pool spill-off solution and removing user deposited bio-materials from the received spill-off solution;
b. a particle filter for removing particles from the pool spill-off solution;
c. a heater for raising the temperature of the double filtered solution; and
d. a photonic emitter for irradiating bacteria, viruses and fungus cells in the solution heated solution.

12. The liquid solution treatment system of claim 11, further comprising a pump for providing pressure to urge the spill-off solution through one or more filters.

13. The liquid solution treatment system of claim 12, wherein said pump pulls the spill-off solution through said biomaterial filter.

14. The liquid solution treatment system of claim 13, wherein said pump pushes the spill-off solution through the particle filter.

15. The liquid solution treatment system of claim 11, wherein said heater raises a temperature of the spill-off solution and increases a saturation point of the spill-off solution.

16. The liquid solution treatment system of claim 11, including a spectrograph and configured to at least intermittently measure quantities or concentrations of specific salts or minerals dissolved or suspended with the spill-off solution.

17. The liquid solution treatment system of claim 16, wherein said spectrograph is in-line with a return path of the spill-off solution and configured to at least intermittently measure quantities or concentrations of specific salts or minerals dissolved or suspended with the spill-off solution flowing in the return path.

18. The liquid solution treatment system of claim 16, further including a supplemental materials injectors to introduce into the solution materials detected by said spectrograph to be below a predefined concentration within the solution.

19. The liquid solution treatment system of claim 18, wherein the said injector is location adjacent to said heater.

20. The liquid solution treatment system of claim 19, wherein said particle filter includes a cleaning mechanism which uses non-solution liquid to remove filtered into a waste reservoir particles from the particle filter in order to extend usability while not preserving said solution.
